(19) United States
(12) Patent Application Publication
(10) Pub. No.: US 2024/0329952 A1
(43) Pub. Date: Oct. 3, 2024

(54) Generating And Formatting A Flowchart From Embedded Objects In Source Code

(71) Applicant: Microsoft Technology Licensing, LLC, Redmond, WA (US)

(72) Inventors: Anitta Maria MILLER, Bellevue, WA (US); Sangeetha MADDERLA, Redmond, WA (US); Cody Ray CRANFILL, Columbia, TN (US); Joshua Thomas NIELSEN, Kent, WA (US); Lori Ann MURRAY, Renton, WA (US); Jason Lancaster MOCK, Seattle, WA (US); Gueorgui Bonov CHKODROV, Redmond, WA (US); Dan Alexandru NICOLESCU, Bellevue, WA (US); Akrem Juneidi BASHA, Minneapolis, MN (US); William Duncan MACKENZIE, Redmond, WA (US)

(21) Appl. No.: 18/190,278

(22) Filed: Mar. 27, 2023

(51) Int. Cl. G06F 8/41

(52) U.S. Cl. CPC G06F 8/433

(57) ABSTRACT

Techniques for generating a workflow diagram automatically from code are described herein. The diagram can be generated in real-time with code changes or as a batch-processing operation to generate drawings as documentation. An extent delineator is identified in the source code. Based on the location of that extent delineator, a determination is made that multiple lines of the source code share a relationship with one another. An extent is formed by grouping those lines together. An AST, which is based on the code, is accessed. Multiple AST nodes are identified. These nodes correspond to the extent. A flowchart is generated based on (i) the AST, (ii) the source code, and (iii) the extent delineator. One of the flowchart nodes commonly represents the multiple AST nodes corresponding to the extent. This flowchart node is annotated with text that generally describes that node's logic.

### BACKGROUND

When a program is being developed, one of the first steps often involves creating a flowchart or workflow diagram that outlines the proposed logic for the program. This flowchart operates as a guide for developing the source code. It also operates to help developers think through many of the issues that the program will likely face, so the developers can then create logic to address those issues. During the actual development of the program, developers will often incorporate new logic changes in the code's decision steps or will integrate new enrichments to the code.

There are various programs available for manually creating a flowchart. One problem that exists today is that no manual solution for generating or updating the flowchart can keep up with the changes that are made while developing code while also scaling at an enterprise level. What is needed, therefore, is an improved technique for updating flowcharts that represent the changing logic of source code.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Embodiments disclosed herein relate to systems, devices, and methods for generating a flowchart from embedded objects (e.g., extent delineators, text, hints, etc.) in source code.

Some embodiments identify, from within a body of source code, an extent delineator. Based on a location of the extent delineator within the body of source code, a determination is made that multiple lines of the source code share a relationship with one another. An extent is formed by grouping the multiple lines of the source code together. An abstract syntax tree (AST) is accessed, where this AST is generated based on the body of source code. The embodiments identify multiple AST nodes in the AST. The identified AST nodes correspond to the extent. The embodiments generate a flowchart based on (i) the AST, (ii) the source code, and (iii) the extent delineator. One of the flowchart nodes commonly represents the multiple AST nodes corresponding to the extent. This flowchart node is annotated with text, and the text describes the multiple AST nodes as a whole.

Some embodiments determine, based on a location of an identified extent delineator included within source code, that multiple logical lines of code (LLOC), which are included in the source code, share a relationship with one another. The embodiments form an extent by grouping the multiple LLOC. An abstract syntax tree (AST) is accessed, and this AST is generated based on the source code. Multiple AST nodes in the AST are identified. These AST nodes correspond to the multiple LLOC forming the extent. The embodiments generate a flowchart outlining logic defined by the source code. One of the flowchart nodes commonly represents multiple logic operations defined by the AST nodes corresponding to the extent. The embodiments annotate the flowchart node with text. This text collectively describes the multiple logic operations.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example of a code editor that includes code, including multiple logical lines of code (LLOC).

FIG. 2 illustrates an example architecture for generating and formatting a flowchart using embedded objects (e.g., extent delineators, comment text, hints, etc.) in source code.

FIG. 3 illustrates an example of an abstract syntax tree (AST).

FIG. 4 illustrates an example of an extent and an extent delineator.

FIG. 5 illustrates other examples of extent delineators.

FIG. 6 illustrates other examples of extent delineators.

FIG. 7 illustrates other examples of extent delineators.

FIG. 8 illustrates how a flowchart can be generated.

FIG. 9 illustrates examples of extents.

FIGS. 10, 11, 12, 13, 14, and 15 illustrate various examples of flowcharts.

FIG. 16 illustrates an example of a customization that can be made to a flowchart by embedding a hint in the source code.

FIG. 17 illustrates a customized flowchart.

FIG. 18 illustrates various formatting that can be applied to a flowchart.

FIGS. 19 and 20 illustrate flowcharts of example methods for generating workflow diagrams.

FIG. 21 illustrates an example computer system that can be configured to perform any of the disclosed operations.

### DETAILED DESCRIPTION

Embodiments disclosed herein relate to systems, devices, and methods for generating and optionally formatting a flowchart from embedded objects (e.g., extent delineators, comment text, hints, etc.) in source code. The flowchart diagram can be generated automatically from code. Also, the diagram can be generated in real-time with code changes or as a batch-processing operation to generate drawings as documentation.

Some embodiments identify an extent delineator in a body of source code. Based on a location of that extent delineator, a determination is made that multiple lines of the source code share a relationship with one another. An extent is formed by grouping those lines together. In some cases, an extent can be based on a selection experience in a coding editor. For instance, an example of an extent can be the selection of certain lines of code. An abstract syntax tree (AST), which is based on the code, is accessed. Multiple AST nodes are identified. These nodes correspond to the extent. A flowchart is generated based on (i) the AST, (ii) the source code, and (iii) the extent delineator. One of the flowchart nodes commonly represents the multiple AST nodes corresponding to the extent. This flowchart node is annotated with text that generally describes the multiple AST nodes.

Some embodiments determine, based on a location of an extent delineator included in source code, that multiple logical lines of code (LLOC) share a relationship. The embodiments form an extent by grouping these multiple LLOC. An AST is accessed. Multiple AST nodes are identified. These AST nodes correspond to the multiple LLOC forming the extent. The embodiments generate a flowchart outlining logic defined by the source code. As used herein, the terms “logic” and “logical operations” generally refers to a set of actions or elements arranged in a manner so as to achieve a specific task or desired outcome. One of the flowchart nodes commonly represents logic operations defined by the AST nodes corresponding to the extent. The flowchart node is annotated with text, which collectively describes the logic.

### Examples of Technical Benefits, Improvements, and Practical Applications

The following section outlines some example improvements and practical applications provided by the disclosed embodiments. It will be appreciated, however, that these are just examples only and that the embodiments are not limited to only these improvements.

When a program is being developed, one of the first steps often involves creating a flowchart that outlines the logic for the program. This flowchart operates as a guide for developing the source code. It also operates to help developers think through many of the issues that the program will likely face, so the developers can then create logic to address those issues. During the actual development of the program, developers will often incorporate new logic changes in the code's decision steps or will integrate new enrichments to the code. One problem that exists today is that no manual solution for generating or updating the flowchart can keep up with these changes while also scaling at an enterprise level. The disclosed embodiments solve the problem of maintaining accurate flow charts representing the logic of a program's source code.

To do so, the embodiments intelligently group logically related program statements into extents. These extents are often defined by or identified through the use of extent delineators, one of which can be in the form of a code comment. The flowchart can then be generated and/or updated by integrating comments into the source code. When the comments are updated, the embodiments update the flowchart, thereby rendering an accurate and up-to-date flow chart through the development process's lifecycle.

Experienced developers read large amounts of code. It is often the case, however, that these developers do not attempt to read the code from beginning to end like one would read a book. Instead, they glimpse at the method/function signatures and occasional comments that are sprinkled through the code. Doing so allows them to mentally construct a global picture. Traditionally, one of the primary ways to convey such global understanding to non-coders was by manually creating a workflow diagram (aka a flowchart). Looking at the diagram allows non-coders to understand the logic at a level of abstraction and to express opinions about what should be done differently. Unfortunately, the price to get such feedback was manual work to maintain the workflow diagrams so that they remained in sync with the code. If a top-down definition of a process changed, somebody would have had to spend time to update not only the code but also the flowchart.

Beneficially, the disclosed embodiments are able to generate a workflow diagram automatically from extents in the code, which may include comments. Doing so eliminates the necessity of manual work to create diagrams and to keep the code and the diagrams always in sync. It also allows leveraging of the ecosystem of tools for code version control, showing version differences, and even automatic deployment. Additionally, there is now no need to keep the diagrams as extra files.

Flowcharts play a beneficial role in displaying information and assisting reasoning by making explicit the structure of problems, tasks, and logic. As indicated above, this process can be quite costly if the code changes or if new features are introduced into the program. Advantageously, the embodiments enable the generation of a scalable and low-cost graphical representation of the logic that is included in source code. In some cases, these benefits are achieved by auto-generating the flowchart based on comments in the code.

Beneficially, the disclosed diagrams can be produced from the code. The diagrams represent a level of abstraction such that they do not or might not show all of the code details. The embodiments also beneficially provide a real-time interactive experience in which the developer writes the code and the diagram is auto-updated.

It is worth observing that there are some products that do the opposite. That is, these products generate code from an existing diagram. There are also products that claim to be “low-code” and “workflow,” but the developer is required to define every step and decision, which is essentially just coding. In contrast, the disclosed embodiments support a wide range of options. For instance, the embodiments can operate in a scenario involving an isomorphic diagram to a scenario involving top-level pseudo-code in which comments are interleaved into scripts of arbitrary size and complexity.

By following the disclosed principles, additional benefits will also be realized. For instance, the source code will be more legible because the code will be populated with descriptive comments. The embodiments also incentive the use of established and correct coding principles, thereby bringing a level of standardization to how code is developed. The disclosed processes can also help improve version control of code as well as provide documentation as to how the code has changed over time. Accordingly, these and many other benefits will now be described in more detail throughout the remaining portions of this disclosure.

### Developing Source Code

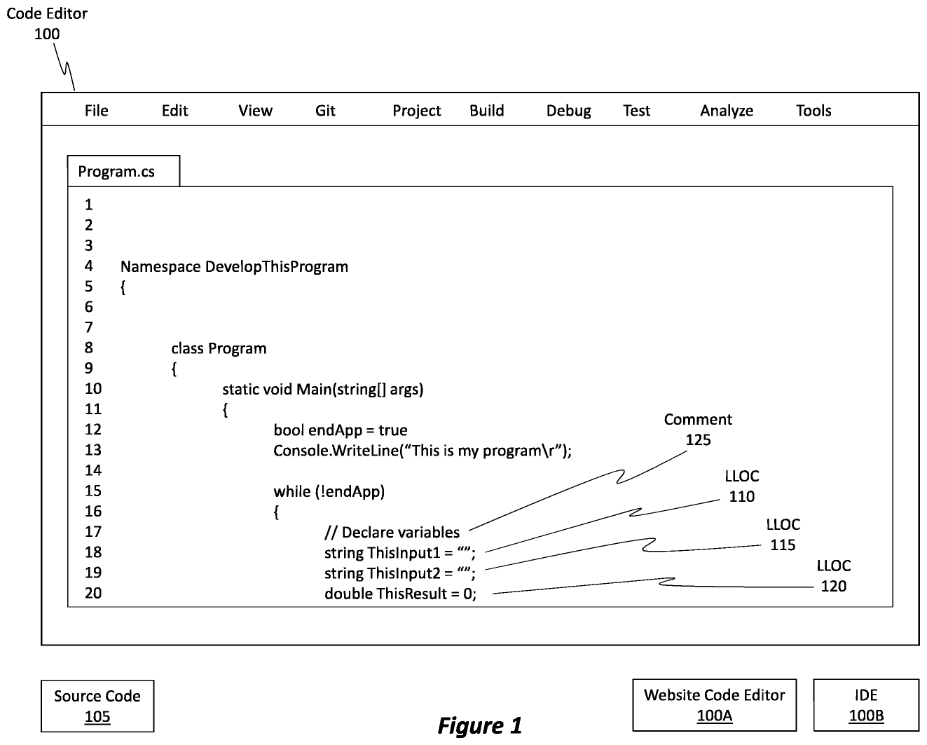

Attention will now be directed to FIG. 1, which illustrates an example code editor 100 that may be used to assist a developer in developing a software application. The code editor 100 can be any type of code editor. For instance, in some scenarios, the code editor 100 can be in the form of a website code editor 100A hosted in an online platform. In some scenarios, the code editor 100 can be in the form of an integrated development environment (IDE) 100B. Other types of code editors can be used, even ones configured as a simple text editor.

As shown, the code editor 100 is being used to develop source code 105. The source code 105 includes any number of logical lines of code (LLOC), such as LLOC 110, 115, and 120. As used herein, an “LLOC” refers to a program statement that is implemented by a code development application. An LLOC can optionally be presented on multiple different lines in the code editor 100. Regardless, an LLOC is an executable statement that will be interpreted by a compiler.

An LLOC should be viewed as being distinct relative to statements that will not be compiled and executed even though those statements are included in the source code 105. One example of a non-executable statement is a comment, such as comment 125. Comment 125 typically includes text used to help improve the readability of the source code 105 and/or to otherwise provide additional useful information describing various LLOC. In the example shown in FIG. 1, comment 125 is shown has having a number of delimiters or delineators in the form of the forward slashes (“//”). Different programming languages will use different delimiters to reflect whether a statement is a comment.

Comment 125 is associated with text, which reads “Declare variables.” In the lines of code following the comment (e.g., lines 18, 19, and 20), the program includes a number of declarations for a number of variables. Comment 125 is thus providing additional context with regard to the next few lines of code.

### Example Architecture

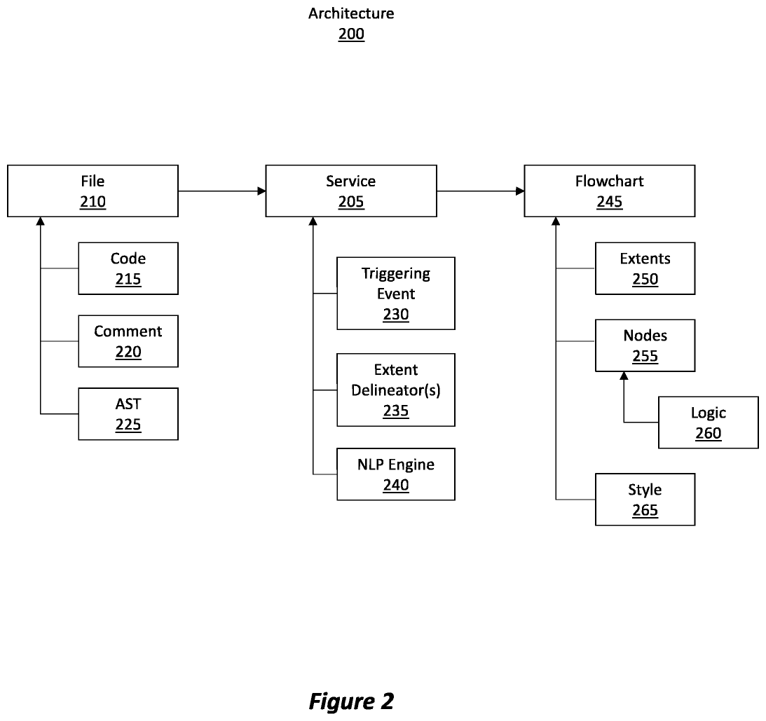

Attention will now be directed to FIG. 2, which illustrates an example architecture 200 that is able to provide the benefits mentioned earlier and that is able to facilitate the generation of a flowchart based on (i) source code, (ii) certain identified delineators embedded in that source code, and (iii) an abstract syntax tree (AST).

Architecture 200 is shown as including a service 205. As used herein, the term “service” refers to an automated program that is tasked with performing different actions based on input. In some cases, service 205 can be a deterministic service that operates fully given a set of inputs and without a randomization factor. In other cases, service 205 can be or can include a machine learning (ML) or artificial intelligence engine.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some cases, service 205 is a local service implemented on a computing device. In some cases, service 205 is a cloud service operating in a cloud environment. In some cases, service 205 can be a hybrid type of service that includes a local component operating on a local system and a cloud component operating in a cloud environment.

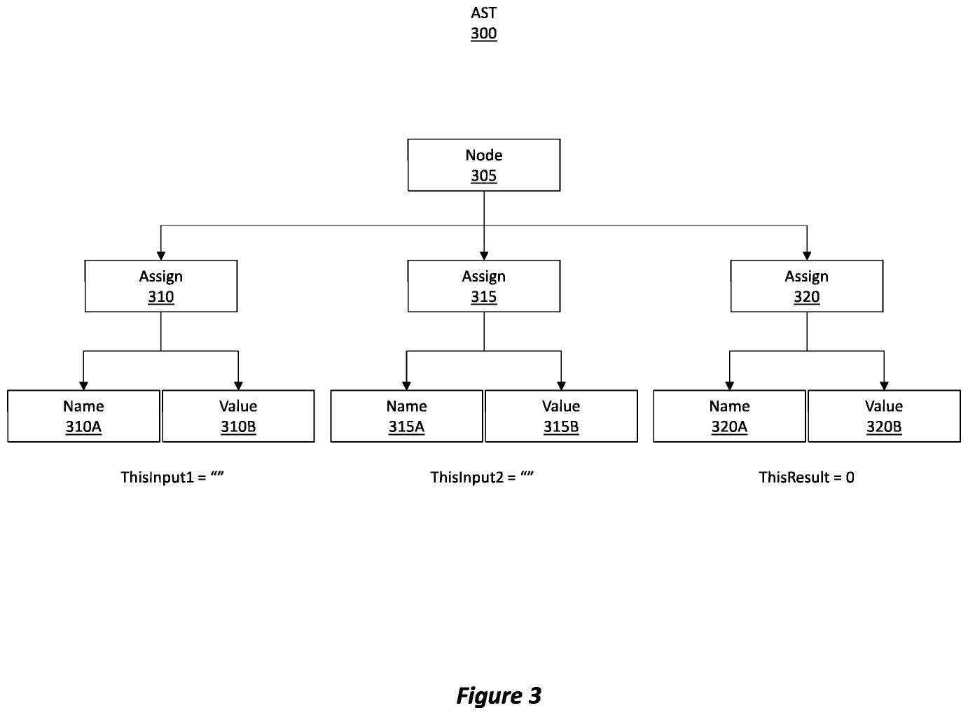

Service 205 is shown as accessing a file 210. File 210 includes source code 215, such as the source code 105 from FIG. 1. The code 215 can include any number or type of comments, as shown by comment 220. Comment 220 is representative of the comment 125 from FIG. 1. File 210 can also include or be associated with an abstract syntax tree (AST) 225. Some text, particularly source code, often has a syntactic structure. An “AST” is a tree-based view or hierarchical view of that text's structure. FIG. 3 provides a simplistic example.

FIG. 3 shows an AST 300, which is representative of the AST 225 of FIG. 2. AST 300 includes any number of AST nodes. As an example, all of the blocks shown in FIG. 3 can be viewed as being different AST nodes. Notice, the nodes are arranged in a tree-like structure, with the node 305 being a top-most node, and then a number of child nodes underneath. Each node in the AST 300 represents a logical operation for the source code 215 of FIG. 2 and the source code 105 of FIG. 1.

As an example, consider the assign 310 node with its two children (e.g., name 310A and value 310B). This assign 310 node corresponds to the LLOC 110 of FIG. 1, where the variable “ThisInput1” is being assigned a value of “ ”. AST 300 represents this logical operation using the assign 310 node, the name 310A node, which corresponds to the name of the variable (e.g., “ThisInput1”), and the value 310B node, which corresponds to the value for that variable (e.g., “ ”). The assign 315 node, name 315A node, and value 315B node correspond to the LLOC 115. Similarly, the assign 320 node, name 320A node, and value 320B node correspond to the LLOC 120.

Returning to FIG. 2, when the code 215 is being developed in an IDE, it is typically the case that the AST 225 is generated in response to a save event for that code 215. When the code 215 is being developed in a website code editor, then the code editor may be tasked with triggering the generation of the AST 225 in accordance with a predefined frequency. That is, the coding editor can trigger the saving of a code file, perhaps in accordance with a defined frequency or perhaps based on detected changes. The AST 225 is then generated as a result of the file changing. Thus, the AST 225 is generated based on the code 215. The generation of the AST 225 can be viewed as a triggering event 230 by the service 205 as to when the service 205 will then trigger the generation of a flowchart, as will be discussed shortly.

FIG. 2 also shows how the service 205 is able to identify, from within the code 215, any number or type of so-called extent delineator(s) 235. As used herein, an “extent” refers to a number of LLOCs that have been identified as sharing a relationship with one another and have been grouped together. As used herein, an “extent delineator” refers to a machine recognizable marker that facilitates the identification of LLOCs that can be grouped together to form an extent. In accordance with the disclosed principles, multiple different types of markers can operate as extent delineators. Examples of such markers will be provided shortly.

Service 205 also includes or has access to a natural language processing (NLP) engine 240. As used herein, the term “NLP” generally refers to a computing ability, often performed by a machine learning algorithm, to recognize text and spoken words in a manner that is similar to how a human recognizes that text and spoken words. More generally, an NLP engine is able to determine not only a syntactic meaning to text or audio input but also a semantic meaning to that input. Optionally, the service 205 can use the NLP engine 240 to interpret the text included as a part of the comment 220 and/or the code 215. Further details on this functionality will be provided later.

One task of the service 205 is to use the code 215, the comment 220, and the AST 225 to generate an easily readable flowchart 245 that generally outlines the logic of the code 215. Generally, the service 205 is able to group LLOCs together to form multiple extents 250 and then generate flowchart nodes 255 to represent those extents 250 in a compact and intuitive manner. That is, the flowchart 245 is designed to provide an easy-to-read representation of the logic 260 that is included in the code 215. The flowchart 245 can also have various different style 265 attributes, as will be discussed in more detail later.

### Examples of Extent Delineators

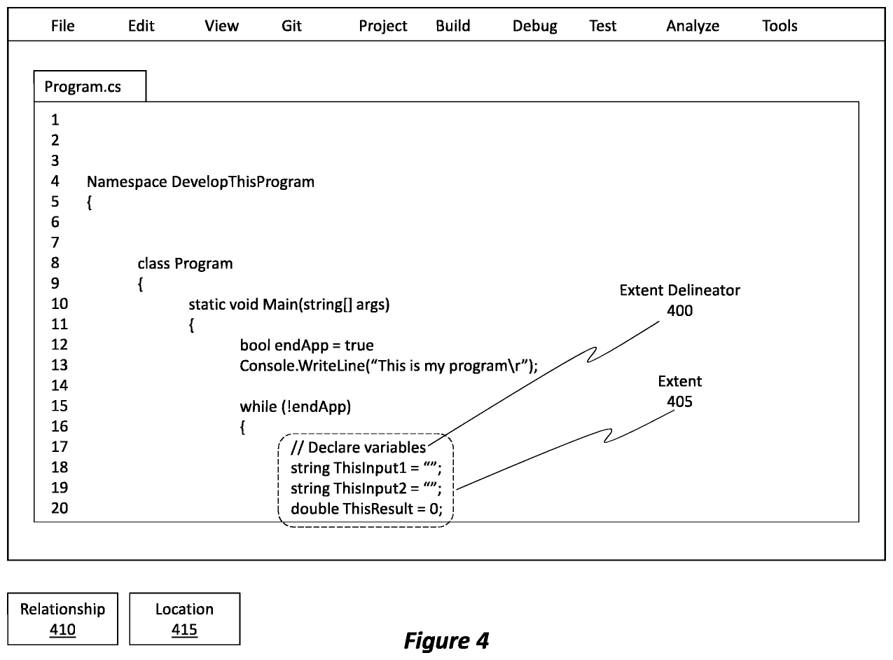

FIGS. 4, 5, 6, and 7 provide further details regarding extents and extent delineators. FIG. 4 shows a recognized extent delineator 400 in the form of a comment embedded in the source code. FIG. 4 also shows an extent 405, which includes a number of LLOCs. Here, this extent 405 is formed using the variable assignment or declaration statements. A review of the source code determined that these LLOCs are related to one another because each one of these LLOCs is a variable assignment statement. Thus, these LLOCs share a relationship 410 with one another. The comment is also related to this extent 405 because the comment is generally describing what is happening in those lines of code. Ending or terminating an extent can optionally be achieved by adding an empty line, by closing a bracket (e.g., an if-then statement bracket), or by various other techniques as will be described herein. Use of the bracket is one reason as to why the embodiments rely on the AST so as to not add lines outside of a specific code block. Here, the comment is a type of extent delineator. The embodiments are also able to determine a location 415 of the extent delineator 400 within the body of source code. For instance, in this case, the location 415 is line 17 for the extent delineator 400.

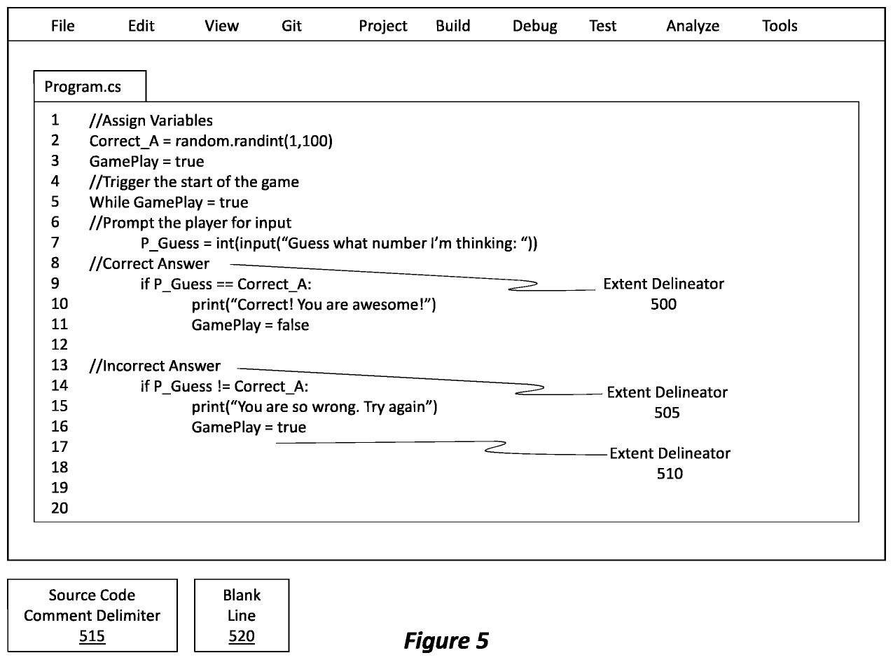

FIG. 5 shows additional examples of extent delineators that are represented in the form of a comment. For instance, the comment “//Correct Answer” is determined to be an extent delineator 500. Similarly, the comment “//Incorrect Answer” is determined to be an extent delineator 505. FIG. 5 illustrates various different scenarios in which an extent can be defined. In one scenario, an extent is defined using a comment as an extent delineator. In another scenario, an extent is defined using a line break as an extent delineator.

Different markers can also serve as extent delineators. For instance, the blank line at line 17 is determined to be an extent delineator 510. Thus, in some implementations, a source code comment delimiter 515 (e.g., the comment “//Correct Answer”) can be recognized as being an extent delineator. Similarly, a blank line 520 can be recognized as being an extent delineator.

The lines of code between various extent delineators can be determined to be related to one another and can be grouped together to form an extent. For instance, the lines of code starting at line 9 and ending at line 11 can be grouped together to form an extent based on the extent delineator 500. The presence of a different extent delineator can indicate the end to a previous extent. For instance, extent delineator 505 can trigger that a new extent is being formed by lines 14, 15, and 16. Extent delineator 510 triggers that the previous extent ends at line 16.

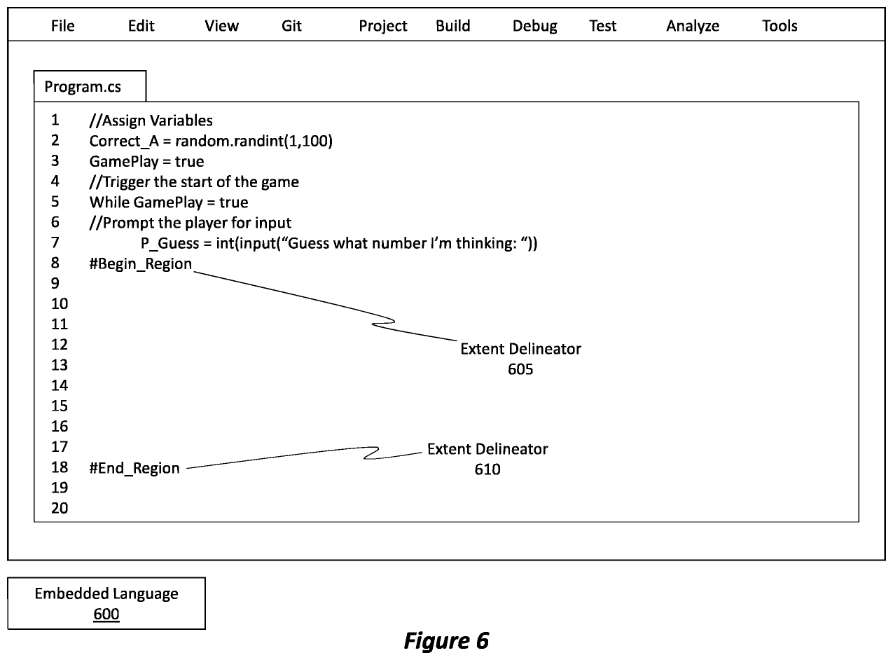

In some cases, embedded language can be used as an extent delineator. For instance, FIG. 6 shows that certain embedded language 600 can be used to define a range of LLOC that is to be grouped together. In particular, extent delineator 605 and extent delineator 610 are examples of embedded language that group or cordon various LLOC off so those LLOC can be grouped together in the same extent.

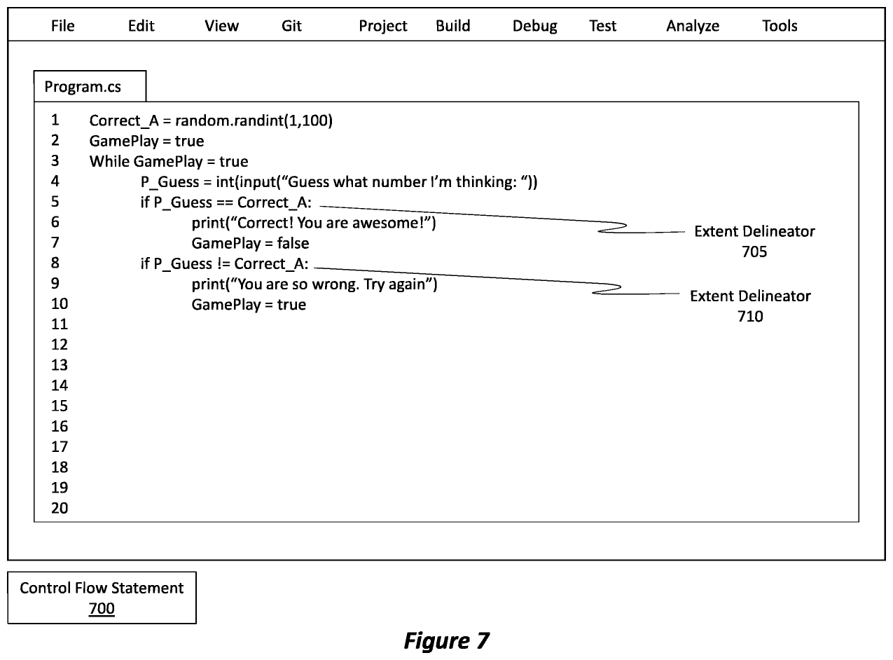

FIG. 7 shows that a control flow statement 700 can also operate as an extent delineator. For instance, line 5 shows an “if-then” statement. This if-then statement is an example of a control flow statement. In this example, control flow statements can operate as extent delineators, as shown by extent delineator 705 and 710. Accordingly, the embodiments are able to analyze any type of text in a file or body of source code. The embodiments can operate using a predefined list of recognized extent delineators. When those types of extent delineators are recognized in the source code, the embodiments are able to group the associated LLOCs with those delineators to form various different extents. The LLOCs included in an extent are determined to share a relationship with one another, as discussed previously. As various non-limiting examples, that relationship can be a control flow relationship, an assignment or declaration relationship, a predefined relationship (e.g., as in the case where the embedded language was used), a function relationship, or any other type of relationship.

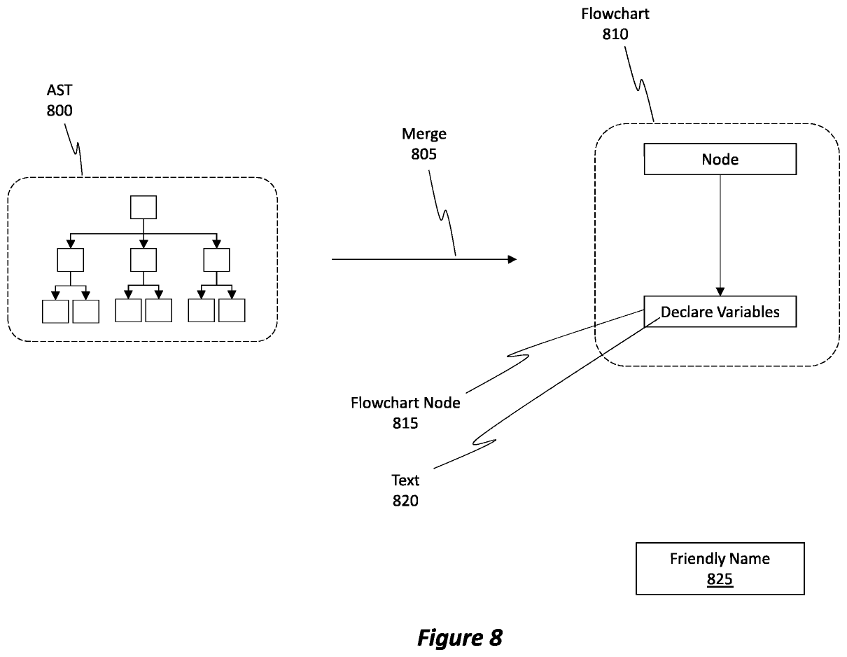

FIG. 8 shows one example of how a flowchart can be created. The embodiments are able to access an AST 800 and the source code. The embodiments analyze the source code to group LLOCs together to generate any number of extents using identified extent delineators. The embodiments are able to analyze the nodes of the AST 800. Whichever nodes in the AST 800 are associated with the LLOCs grouped together in the form of an extent can be merged together, as shown by merge 805. A flowchart 810 is then formed.

This flowchart 810 can include any number of flowchart nodes, such as flowchart node 815. Flowchart node 815 includes descriptive text 820, which often has a friendly name 825 or easily readable text. In this example, the flowchart node 815 is a single node in the flowchart 810, but this single flowchart node 815 commonly represents multiple logic statements, operations, or nodes that were included in the AST 800. As an example, the flowchart node 815 commonly represents the assign 310 node, name 310A node, value 310B node, assign 315 node, name 315A node, value 315B node, assign 320 node, name 320A node, value 320B node. Thus, multiple logical nodes in an AST can be singularly represented by a single flowchart node in the flowchart 810.

It should be noted how the visualization can operate using any code language or code parser (e.g., a code editor) or scripting language (e.g., PowerShell). An example will be helpful.

Suppose a developer is attempting to define a new process in the source code. At the beginning, the script will be empty. The workflow diagram will also be empty. The developer may then type the first two lines, which may include a comment and then a PowerShell empty statement. The embodiments will then display a first block in the flowchart diagram. The user can edit the comment in the text to see how changes are instantaneously reflected on the diagram.

The developer may then type the rest of the pseudo-code. The developer can also observe how the diagram changes in real-time. Clicking on a shape in the diagram can trigger the highlight of the corresponding code. In this mode, the flowchart generator is used instead of other (e.g., manual) design tools in which the developer builds the diagram from shapes and connectors. In contrast, here, the developer can simply type a few lines of text, and the flowchart is automatically created.

The embodiments can also be implemented using existing script. For instance, consider a scenario where there is a paragraph starting with a comment followed by several code lines. This data is translated into the first step of the diagram. Subsequent paragraphs also result in steps. A comment, which (as an example) is just below an if-statement, can be interpreted as a decision shape. Comments on decision branches can be visualized as blocks of the diagram containing further steps.

In this mode, if the script is commented properly it takes essentially no effort on the developer's part to create a diagram. The disclosed tools/embodiments support both interactive editing (e.g., diagram changes in real-time) and batch processing of one or more script files into diagrams.

As indicated earlier, the embodiments make use of an AST. The AST is the first step in translating any programming language to machine-usable form. While the implementation of AST has slight language-dependent differences, the embodiments generally receive, as input, a text file that includes the programming language. The output is a tree of objects representing each statement of the language. The embodiments use this tree to construct a workflow map or flowchart.

### Further Details on Generating a Flowchart

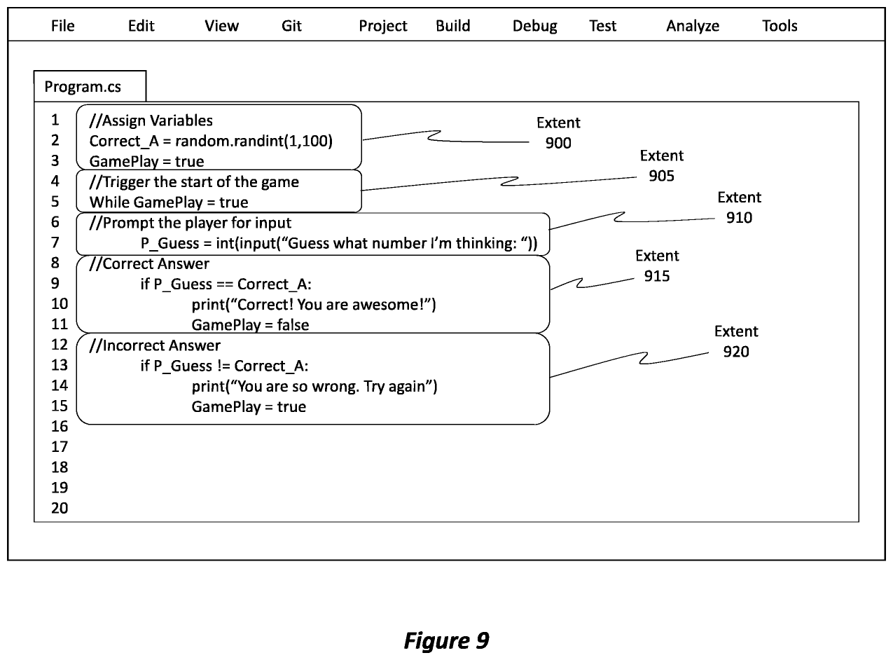

FIG. 9 shows a body of source code. In accordance with the disclosed principles, the embodiments are able to identify multiple LLOCs that share a relationship with one another. These LLOCs are grouped together to form an extent. This grouping is typically facilitated through the identification of an extent delineator.

In FIG. 9, lines 1, 2, and 3 are grouped together to form the extent 900. Lines 4 and 5 are grouped together to form extent 905. Lines 6 and 7 are grouped together to form extent 910. Lines 8, 9, 10, and 11 are grouped together to form extent 915. Lines 12, 13, 14, and 15 are grouped together to form extent 920.

The embodiments are able to access an AST corresponding to the code shown in FIG. 9. The embodiments use this AST as well as the source code and the identified extents to generate a flowchart that outlines the various logic included in the source code.

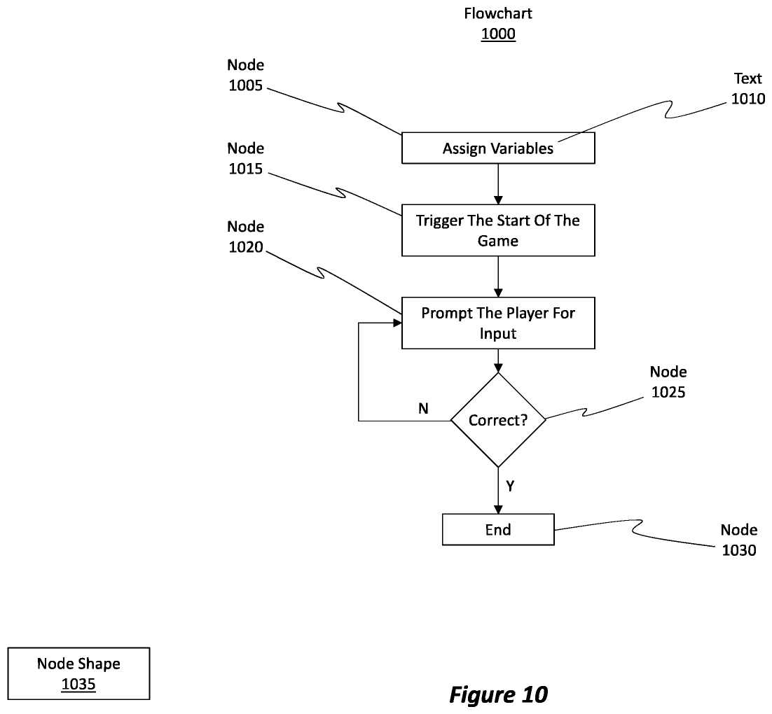

FIG. 10 shows a flowchart 1000 that is generated based on the source code shown in FIG. 9. This flowchart 1000 includes various different flowchart nodes, such as node 1005. Notice, node 1005 has been annotated to include text 1010.

In this example scenario, the text 1010 was pulled, extracted, or otherwise generated based on the comment shown in line 1 of the code in FIG. 9. For instance, the comment in line 1 was identified as being an extent delineator. Lines 2 and 3 included program statements for assigning values to variables. As a result, those two lines of code were determined to be related to one another. The comment included text generally describing what was happening in lines 2 and 3. This comment text included the following language: “Assign Variables.”

That same language (i.e. the language in the comment) was used to annotate the flowchart node 1005. Thus, the embodiments are able to pull language from the source code (e.g., comment language) and use that language to annotate flowchart nodes. Notice, nodes 1015, 1020, 1025, and 1030 also include language pulled from the comments shown in FIG. 9.

The different flowchart nodes can optionally have different shapes, as represented by node shape 1035. For instance, nodes that generally refer to program declaratory statements are shown has having a rectangular shape. On the other hand, nodes that refer to program flow control statements (e.g., if-then statement, while statements, for statements, go to statements, etc.) are shown as having a rhomboid shape (e.g., see node 1025). The embodiments are able to modify the shape of a flowchart node based on any predefined criteria.

It should also be noted how a single node can represent multiple LLOCs. Stated differently, a single flowchart node can represent multiple logic nodes that were included in an AST. As an example, the single node 1005 commonly represents two different logic statements. In particular, node 1005 represents the statement shown in line 2 of FIG. 9 as well as the statement shown in line 3.

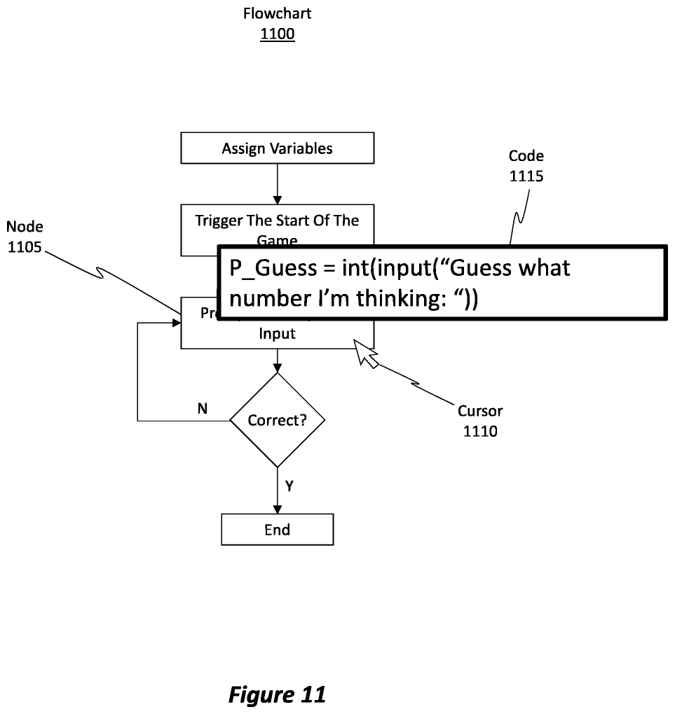

FIG. 11 shows a flowchart 1100 that includes a flowchart node 1105. In this example scenario, a user's cursor 1110 is shown as hovering over the node 1105. Some embodiments configure the flowchart 1100 to trigger the display of code 1115 that corresponds to the node 1105. For instance, the node 1105 is a node that refers to an extent in which the user is being prompted to provide input. More particularly, node 1105 corresponds to the source code shown in extent 910 of FIG. 9. Optionally, when the cursor 1110 hovers over a node, the embodiments can trigger the display of that node's corresponding source code. Optionally, the embodiments can trigger the display of the AST nodes corresponding to that flowchart node. The code 1115 is shown as being displayed simultaneously with the flowchart 1100. Optionally, the code 1115 can be displayed in a view that overlaps at least a portion of the node 1105.

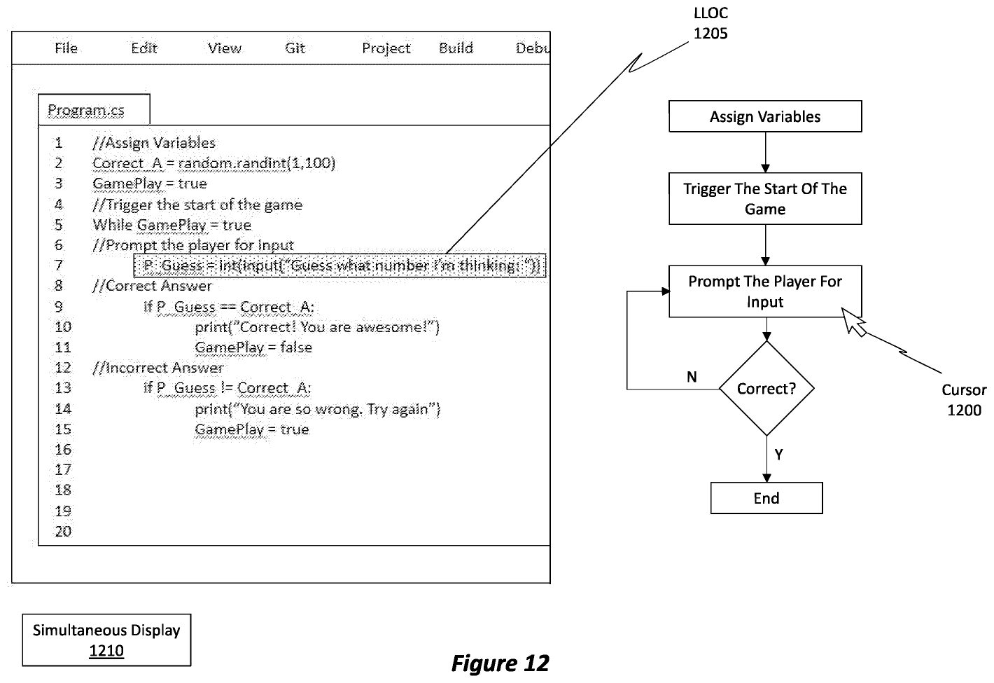

FIG. 12 shows a scenario where the user's cursor 1200 is hovering over the same flowchart node. In this example scenario, the embodiments have triggered the display of the code editor that includes the LLOC 1205 corresponding to the node over which the cursor 1200 is hovering. Optionally, the LLOC 1205 can be visually emphasized in some manner, such as through the use of highlighting, bold text, flashing text, or any other visual emphasis technique. In this example scenario, the code editor, including the LLOC 1205, is displayed simultaneously with the flowchart, as represented by simultaneous display 1210.

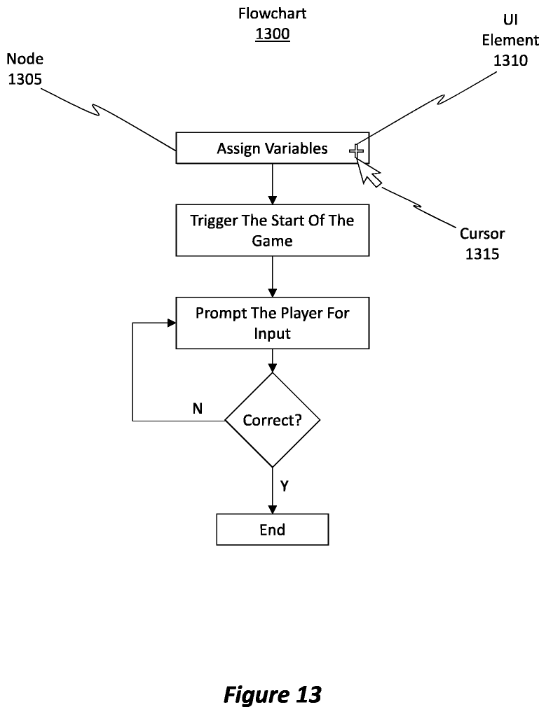

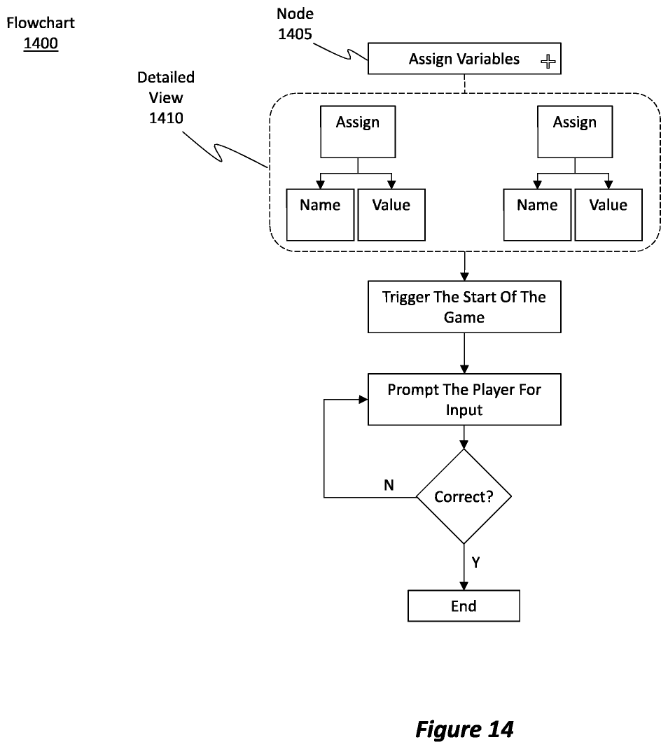

FIG. 13 shows a flowchart 1300 that includes a node 1305. Node 1305 includes a user interface (UI) element 1310. The user's cursor 1315 can optionally click the UI element 1310 to trigger the display of information for that node 1305, as shown in FIG. 14.

FIG. 14 shows a flowchart 1400 that is representative of the flowchart 1300 from FIG. 13. In this scenario, the user's cursor was used to click on the UI element 1310. As a result of clicking that UI element 1310, the embodiments triggered the display of additional information for the node 1405, as shown by the detailed view 1410. In this example scenario, the detailed view 1410 includes the various AST nodes that were generated for lines 2 and 3 of the source code shown in FIG. 12. These AST nodes were assignment nodes. Thus, the embodiments can optionally trigger the display of more granular information for a particular node. That granular information can optionally include various AST nodes and/or source code.

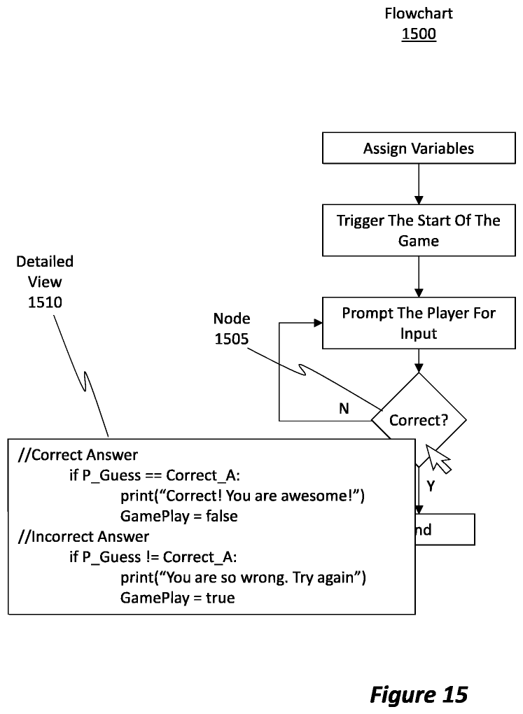

FIG. 15 shows yet another flowchart 1500. Here, a cursor is hovering over or optionally selecting a node 1505. In response to that action, the embodiments triggered the display of a detailed view 1510. Notice, the embodiments are displaying the code from lines 8 through 15 of the source code shown in FIG. 9. Lines 8 through 11 corresponded to extent 915, and lines 12 through 15 corresponded to extent 920. In this scenario, a single flowchart node (e.g., node 1505) is being used to represent multiple different extents (e.g., extents 915 and 920). The embodiments determined that these two extents shared a relationship with one another and could be logically merged or combined with one another, resulting in a single flowchart node representing both of those extents. Thus, not only might LLOCs share a relationship with one another, but different extents might share a relationship with one another. In this example scenario, the two extents were identified as being alternative options as a part of a program flow control scenario.

### Customization of the Flowchart

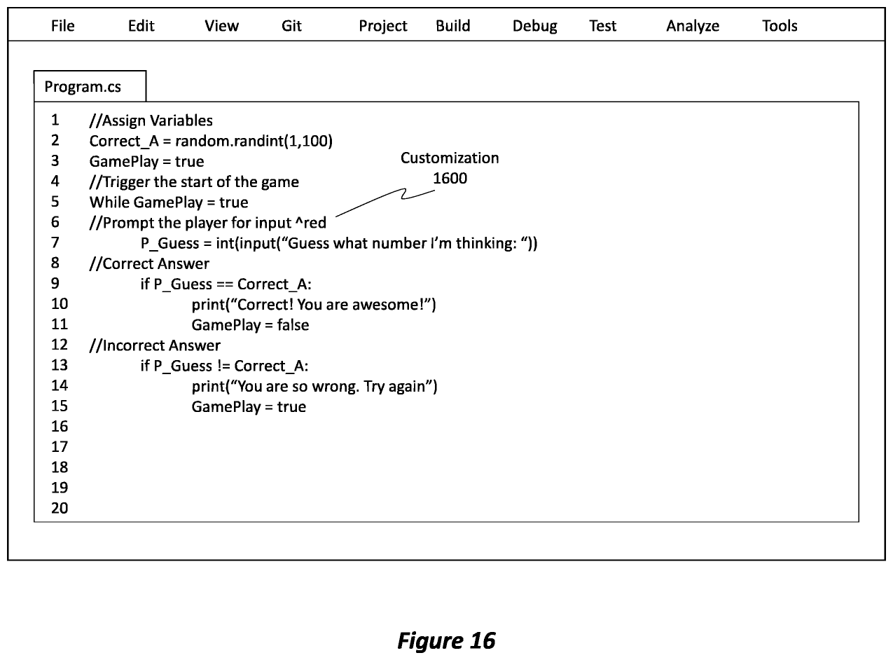

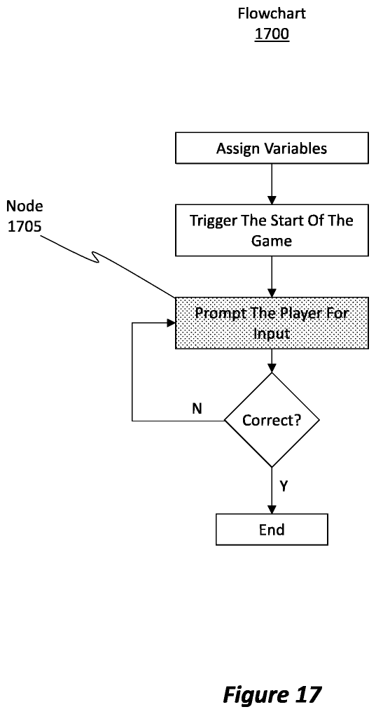

Different customizations can be applied to the flowchart. Some of these customizations can be automatically performed, such as the size of the nodes, the placement of the nodes within a display window, and optionally the text that is used to annotate a node. Some of these customizations can be manually defined. An example is shown in FIGS. 16 and 17.

FIG. 16 shows a code editor displaying source code. Line 6 of that source code is a comment, and this comment is being used as an extent delineator. The embodiments are able to allow a user to embed a flowchart customization 1600 in the source code (e.g., in the comment). This embedded customization 1600 will alter how the resulting flowchart appears. Thus, a user can make in-line text inputs to the source code, and those in-line inputs can be viewed by the embodiments as being customizations that will alter how a flowchart will appear.

In this example scenario, the user typed “\hat{ }red” in the comment in line 6. The carrot “\hat{ }” with the parameter “red” can be referred to as “hints” and will be interpreted by the embodiments as a customization in which the resulting flowchart node for the extent associated with the extent delineator of line 6 will appear as having a red color, as shown in FIG. 17.

FIG. 17 shows a flowchart 1700 that includes a node 1705. Node 1705 corresponds to lines 6 and 7 of the source code shown in FIG. 16. Notice, the node 1705 has shading. This shading would appear to have a red color, as defined by the customization 1600 of FIG. 16.

In addition to color customizations, the embodiments allow for other types of customizations to be entered in-line in the source code via the use of hints. Such customizations include, but certainly are not limited to, the size of a node, the placement of a node relative to the placement of other nodes in the flowchart, the placement of a node with respect to a display screen, the text that will be used to annotate a node, how or when to wrap text included in a node, and so on.

Regarding the text, some embodiments are configured to extract all of a comment's text and use the entirety of that text to annotate a flowchart node. That text can be wrapped inside a node. Optionally, the size of the text can also be modified to ensure that the entirety of the text fits inside the node. As another option, the size of the node and/or the size of the text can be modified.

Some embodiments, on the other hand, perform natural language processing (NLP) on the comment text in an effort to condense or reduce the amount of text that will populate a flowchart node. Optionally, if no comment text is present, the NLP engine can even analyze the source code of an extent and automatically generate text and then annotate the corresponding flowchart node with that text. Thus, in some implementations, the NLP engine can be used to automatically create comments for source code. An example will be helpful.

Suppose a comment included the following text: “The following five lines of code are all concerned with assigning a value to a corresponding variable.” The embodiments can use an NLP engine (e.g., the NLP engine 240 of FIG. 4) to analyze this text. The NLP engine 240 may be tasked with generating text for a flowchart node, where that text is based on the comment text. Because flowcharts are meant to be brief, the NLP engine 240 may determine that a shortened form of the comment text is warranted. After analyzing the comment text, the NLP engine 240 may determine the following language is sufficient to annotate the flowchart node: “Assign Variable Values.” That text is based on the text in the comment, and that text can be used to annotate the flowchart node.

As another example, the node 1505 in FIG. 15 includes a single word of text (e.g., “Correct?”). Despite this node being associated with multiple different extents and multiple different comments, the embodiments were able to significantly reduce the comment text and generate a brief phrase that adequately captures the logic associated with the corresponding extents (e.g., was the input the player provided correct?).

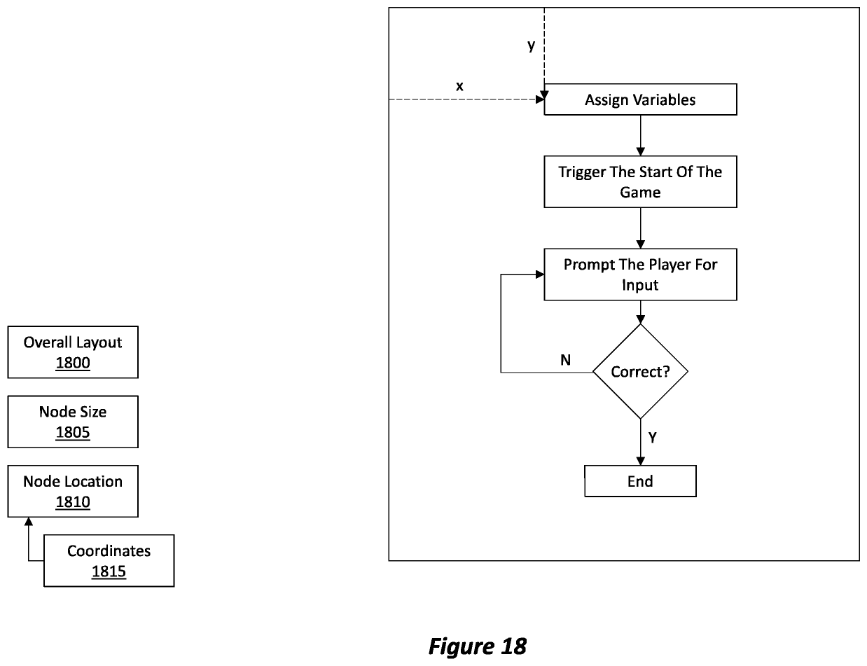

As mentioned previously, various other customizations can also be implemented, as shown in FIG. 18. Such customizations include customizations to a flowchart's overall layout 1800, a node size 1805, a node location 1810, including the coordinates 1815 where a node will be placed. Other customizations include the visual appearance of a node, the appearance of the text within a node, and so on.

In one example scenario, the visual layout can be determined using the following algorithmic processes. To illustrate, one process involves determining whether each step or node of the flowchart is large enough to wrap text.

For each branch in the flowchart, there may be a sequence of steps. One step includes determining what width a node may be set to in order to accommodate text. The height of a node can be determined as the sum of the heights for the steps in the branch plus distance for connector arrows between the nodes.

For a rhombus shaped node, the decision can involve determining the area or size needed to accommodate the text for that node. The determination can further include summing each branch width to determine the width of the rhombus area. The height can be the maximum branch height.

In some implementations, the embodiments can use coordinates to emit an SVG (Scalable Vector Graphics). Optionally, the nodes can be represented as hypertext markup language (HTML) DIV tags. The browser can then calculate the coordinates for the nodes. Connecting arrows can then be added by drawing an SVG on the background. Optionally, the output of the drawing can be a self-contained HTML file, or it can be a page on a web-site implemented with plan HTML/CSS. It can also be integrated with any of the popular web frameworks.

Accordingly, each parser (e.g., code editor) can be tasked with producing an AST, which has internal details specific to the language. To achieve a level of abstraction, the embodiments then detail and keep (i) a summary, such as the comment before a paragraph of code, and (ii) a code extent, which is information that highlights the relevant code in a code editor. The embodiments calculate the visual layout for the flowchart. For example, each step of the diagram is set to be large enough to wrap the summary or annotated text. For each branch (e.g., a sequence of steps), the width and height are determined for the node that will represent the branch.

It is worthwhile to note that the flowchart does not necessarily show all the details that are 1:1 with the code. Instead, the embodiments perform various translations using the AST and then group related logic into a single shape. Different hints can be used to change the visual appearance of the flowchart, such as the shape, color, layout, and so on. For instance, a hint can be used to force the use of a particular layout, such as by grouping multiple paragraphs of code together as opposed to relying on new lines as a separator.

### Example Methods

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

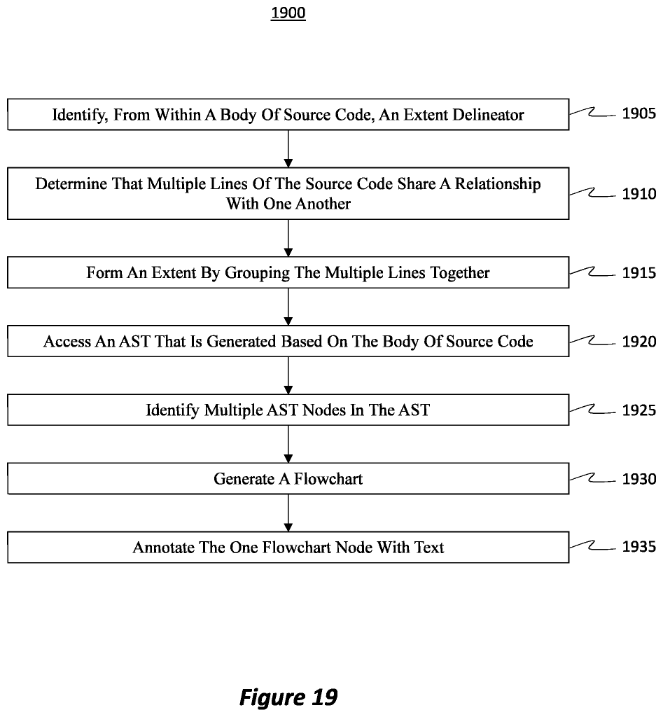

Attention will now be directed to FIG. 19, which illustrates a flowchart of an example method 1900 for generating a flowchart based on source code. Method 1900 can be implemented in the architecture 200 of FIG. 2; furthermore, method 1900 can be performed by the service 205.

Method 1900 includes an act (act 1905) of identifying, from within a body of source code (e.g., source code 105 from FIG. 1), an extent delineator (e.g., extent delineator 400 from FIG. 4). In some implementations, the extent delineator includes one or more of a source code comment delimiter, a blank line in the body of source code, or a source code control flow statement. Optionally, when the extent delineator is a source code comment delimiter, the text that is subsequently used to annotate a flowchart node can be extracted from comment text that is marked as being a comment by the source code comment delimiter.

Optionally, the body of source code can be included in a website code developer. In another scenario, the body of source code can be included in an integrated development environment (IDE).

Act 1910 includes determining, based on a location of the extent delineator within the body of source code, that multiple lines of the source code share a relationship with one another. These lines of code can share any type of relationship with one another based on a detected set of characteristics that are determined to be similar. As various examples, the relationship can be or can include any of the following types of relationships: a function call relationship, a programming routine relationship, a relationship in which similar logic operations are being performed (e.g., variable assignments), or even a manually defined or established relationship.

Act 1915 includes forming an extent by grouping the multiple lines of the source code together. Optionally, the embodiments can include a database or a listing of information. This list can include information identifying which lines of code are related to one another. The list can further include information specifying the type of relationship that exists. This list can be queried or even modified by a user.

Act 1920 includes accessing an abstract syntax tree (AST) that is generated based on the body of source code. The AST can be updated in response to various events or conditions. For instance, when the code is being developed in an IDE, then a save event for the code can trigger the update or generation of the AST. Consequently, the AST can be generated in response to a triggering event. The triggering event can include a change to the source code, a change to a comment, or even a save event for the body of source code. When the code is being developed in a web or online platform, then the platform may be configured to automatically and periodically trigger the generation of the AST. The generation of a resulting flowchart can be triggered in response to the detection of a new or updated AST. Thus, the generation of the flowchart can also be based on the save event.

Act 1925 includes identifying multiple AST nodes in the AST. In this scenario, the identified AST nodes correspond to the extent. By way of example, the assignment nodes in the AST 300 of FIG. 3 are logical operations for the LLOC 110, 115, and 120 of FIG. 1. These assignment nodes thus correspond to the extent forming the LLOC 110, 115, and 120 inasmuch as those nodes defined programmatic operations for implementing the tasks defined by LLOC 110, 115, and 120.

Act 1930 includes generating a flowchart based on (i) the AST, (ii) the source code, and (iii) the extent delineator. One of the flowchart nodes commonly represents the multiple AST nodes corresponding to the extent. The embodiments use, as input, the AST, the source code, and even the extent delineators to generate the flowchart. The flowchart can include any number of nodes, where these nodes reflect the logic of the source code. As indicated above, some of the nodes can represent multiple logic statements or AST nodes in a compressed manner. For instance, a single node can commonly represent any number of variable assignment logic statements that have been grouped together in the same extent. In some cases, a single flowchart node can even commonly represent multiple extents.

Act 1935 includes annotating the one flowchart node with text. The text describes the multiple AST nodes and/or the extent as a whole. As an example, if the flowchart node represents multiple logic statements that define values for variables, then the text can include something like the following: “variable assignments.” In some implementations, the text is extracted from the body of source code, such as the logic code statements or such as comments embedded in the text. In some implementations, natural language processing (NLP) is used to summarize the comment text such that the NLP facilitates in the generation of the text used to annotate the flowchart node.

### Additional Methods

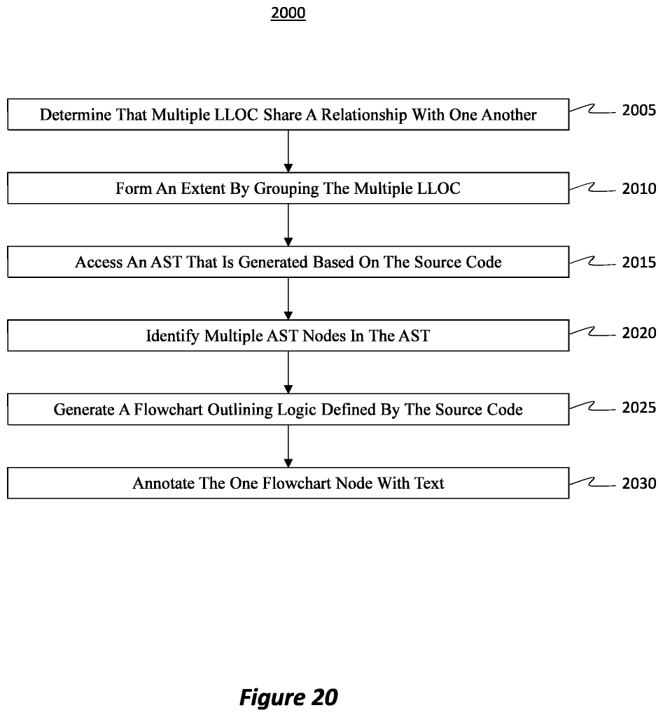

FIG. 20 shows an example method 2000 for generating a flowchart using embedded objects in the source code. Method 2000 can also be implemented by the service 205 of FIG. 2.

Method 2000 includes an act (act 2005) of determining, based on a location of an identified extent delineator included within source code, that multiple logical lines of code (LLOC), which are included in the source code, share a relationship with one another. As an example, the extent delineator may be present in the source code before a number of LLOCs that are related to one another. The location of the extent delineator can operate as a flag for identifying which LLOC share a relationship with one another. Optionally, multiple extent delineators may be present. For instance, a first extent delineator may be present at the beginning of a number of LLOC that share a relationship and a second extent delineator may be present at the end of the LLOC.

Act 2010 includes forming an extent by grouping the multiple LLOC. As mentioned, this grouping action may involve the use of a list, database, or some other tagging mechanism to identify related lines of code.

Act 2015 includes accessing an abstract syntax tree (AST) that is generated based on the source code. In some cases, the process of accessing the AST may include actually generating the AST. In some cases, the AST may be generated by a first device, and the AST is accessed by a second device. Optionally, the AST can be generated by a local device and then uploaded to a cloud environment.

Act 2020 includes identifying multiple AST nodes in the AST. The identified AST nodes correspond to the multiple LLOC forming the extent.

Act 2025 includes generating a flowchart outlining logic defined by the source code, where that logic can be determined based on a review of the AST nodes. Stated differently, the AST nodes provide an outline of the logic of the source code. The embodiments are able to analyze the AST nodes to identify the logic, and the embodiments are able to use that logic to then create an easy-to-read and intuitive flowchart that summarizes and generalizes the logic of the source code. One flowchart node included in the flowchart commonly represents multiple logic operations defined by the AST nodes corresponding to the extent.

Act 2030 includes annotating the one flowchart node with text. The text collectively describes the multiple logic operations. The text is extracted from the source code. The size of the one flowchart node can be dependent on the text. Optionally, source code can be displayed simultaneously with the one flowchart node. The location of the one flowchart node can be dependent on a set of characteristics associated with a display of the flowchart. Those characteristics can include the screen resolution of the display, the screen size of the display, how much of the display is reserved for displaying the flowchart, and so on.

The flowchart can be displayed on a display. When a cursor hovers over the one flowchart node, the multiple LLOC are displayed. In some cases, the one flowchart node includes a user interface (UI) element, and the UI element, when selected, triggers display of the multiple AST nodes. In some cases, selection of the one flowchart node triggers display of the source code, and the multiple LLOC are visually emphasized in the source code.

Accordingly, the embodiments are able to dynamically generate a visualization of a code or script flow while the code or script is being entered. As each parser (e.g., a code editor) produces an AST, the output is abstracted to a higher level relevant to show the script or code flow with parser specific details abstracted out. The code and comments are then mapped to a visual layout artifact. The visual layout is then calculated using an algorithm. As an example, each step of the diagram is large enough to wrap the summary text. By performing these operations, the embodiments enable the generation of a low cost graphical representation of logical operations included in source code.

Accordingly, the embodiments are able to use code in any programming language to display a workflow diagram showing the logic of the code. A real-time interactive visualization can be generated, where, as a user changes the code, the diagram is updated instantaneously. The embodiments provide for a local machine mode, in which the developer can edit code with a favorite code editor (e.g., VS Code). File changes are detected and used for real-time visualization of the workflow diagram. The embodiments also provide for a web-site mode, in which the developer edits the code and can observe the diagram on the same webpage. The embodiments also facilitate one-time processing in which code file(s) are used as input to generate accompanying workflow diagrams as documentation. The embodiments can create self-contained HTML files which include the code, such as script and the workflow diagrams. The embodiments also support usage of version control and continuous deployment pipelines without the need to maintain documentation separately.

Beneficially, the embodiments create a level of abstraction so that the workflow diagram is not necessarily 1:1 with code. Instead, the flowchart represents the algorithm flow in terms of major building blocks such as paragraphs of code. The embodiments beneficially display paragraphs (e.g., lines of code without empty lines in between) as steps of the workflow. The embodiments can display names of decisions and decision branches based on comments around the control statements. Comments can be used to change color and other visual style attributes. Comments can also be used to change the layout such as, for example, by displaying a sub-tree as a block as if it was a separate function.

### Example Computer/Computer Systems

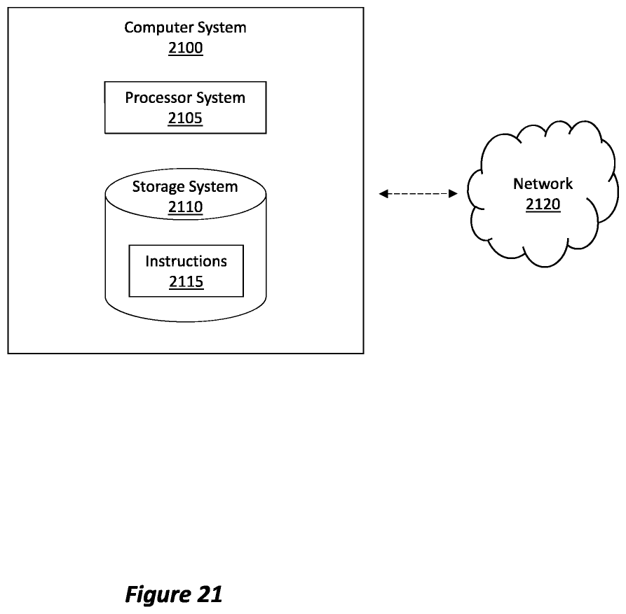

Attention will now be directed to FIG. 21 which illustrates an example computer system 2100 that may include and/or be used to perform any of the operations described herein. For instance, computer system 2100 can implement the service 205 of FIG. 2.

Computer system 2100 may take various different forms. For example, computer system 2100 may be embodied as a tablet, a desktop, a laptop, a mobile device, or a standalone device, such as those described throughout this disclosure. Computer system 2100 may also be a distributed system that includes one or more connected computing components/devices that are in communication with computer system 2100.

In its most basic configuration, computer system 2100 includes various different components. FIG. 21 shows that computer system 2100 includes a processor system 2105 that can include one or more processor(s) (aka a “hardware processing unit”). Computer system 2100 also includes a storage system 2110.

Regarding the processor(s) of the processor system 2105, it will be appreciated that the functionality described herein can be performed, at least in part, by one or more hardware logic components (e.g., the processor(s)). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computer system 2100. The different components, modules, engines, and services described herein may be implemented as objects or processors that execute on computer system 2100 (e.g. as separate threads).

Storage system 2110 can include physical system memory, which may be volatile, non-volatile, or some combination of the two. The term “memory” may also be used herein to refer to non-volatile mass storage such as physical storage media. If computer system 2100 is distributed, the processing, memory, and/or storage capability may be distributed as well.

Storage system 2110 is shown as including executable instructions 2115. The executable instructions 2115 represent instructions that are executable by the processor(s) of computer system 2100 to perform the disclosed operations, such as those described in the various methods.

The disclosed embodiments may comprise or utilize a special-purpose or general-purpose computer including computer hardware, such as, for example, one or more processors and system memory, as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 2100 may also be connected (via a wired or wireless connection) to external sensors (e.g., one or more remote cameras) or devices via a network 2120. For example, computer system 2100 can communicate with any number devices or cloud services to obtain or process data. In some cases, network 2120 may itself be a cloud network. Furthermore, computer system 2100 may also be connected through one or more wired or wireless networks to remote/separate computer systems(s) that are configured to perform any of the processing described with regard to computer system 2100.

A “network,” like network 2120, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 2100 will include one or more communication channels that are used to communicate with the network 2120. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system that generates a flowchart, said computer system comprising:
a processor system; and
a storage system comprising instructions that are executable by the processor system to cause the computer system to:
identify, from within a body of source code, an extent delineator;
based on a location of the extent delineator within the body of source code, determine that multiple lines of the source code share a relationship with one another;
form an extent by grouping the multiple lines of the source code together;
access an abstract syntax tree (AST) that is generated based on the body of source code;
identify multiple AST nodes in the AST, wherein the identified AST nodes correspond to the extent;
generate a flowchart based on (i) the AST, (ii) the source code, and (iii) the extent delineator, wherein one flowchart node included in the flowchart commonly represents the multiple AST nodes corresponding to the extent; and
annotate the one flowchart node with text, wherein the text describes the multiple AST nodes as a whole.

2. The computer system of claim 1, wherein the extent delineator includes a source code comment delimiter.

3. The computer system of claim 1, wherein the extent delineator includes a blank line in the body of source code.

4. The computer system of claim 1, wherein the extent delineator includes a source code control flow statement.

5. The computer system of claim 1, wherein the body of source code is included in a website code developer.

6. The computer system of claim 1, wherein the body of source code is included in an integrated development environment (IDE).

7. The computer system of claim 1, wherein the AST is generated in response to a triggering event.

8. The computer system of claim 1, wherein the text is extracted from the body of source code.

9. The computer system of claim 1, wherein the extent delineator is a source code comment delimiter, and wherein the text used to annotate the one flowchart node is extracted from comment text that is marked as being a comment by the source code comment delimiter.

10. The computer system of claim 9, wherein natural language processing (NLP) is used to summarize the comment text such that the NLP facilitates in generation of the text used to annotate the one flowchart node.

11. A method for generating a flowchart, said method comprising:
based on a location of an identified extent delineator included within source code, determining that multiple logical lines of code (LLOC), which are included in the source code, share a relationship with one another;
forming an extent by grouping the multiple LLOC;
accessing an abstract syntax tree (AST) that is generated based on the source code;
identifying multiple AST nodes in the AST, wherein the identified AST nodes correspond to the multiple LLOC forming the extent;
generating a flowchart outlining logic defined by the source code, wherein one flowchart node included in the flowchart commonly represents multiple logic operations defined by the AST nodes corresponding to the extent; and
annotating the one flowchart node with text, wherein the text collectively describes the multiple logic operations.

12. The method of claim 11, wherein the flowchart is displayed on a display, and wherein, when a cursor hovers over the one flowchart node, the multiple LLOC are displayed.

13. The method of claim 11, wherein the one flowchart node includes a user interface (UI) element, and wherein the UI element, when selected, triggers display of the multiple AST nodes.

14. The method of claim 11, wherein selection of the one flowchart node triggers display of the source code, and wherein the multiple LLOC are visually emphasized in the source code.

15. The method of claim 14, wherein the source code is displayed simultaneously with the one flowchart node.

16. A computer system that generates a flowchart, said computer system comprising:
a processor system; and
a storage system that stores instructions that are executable by the processor system to cause the computer system to:
based on a location of an identified extent delineator included within source code, determine that multiple logical lines of code (LLOC), which are included in the source code, share a relationship with one another;
form an extent by grouping the multiple LLOC;
access an abstract syntax tree (AST) that is generated based on the source code;
identify multiple AST nodes in the AST, wherein the identified AST nodes correspond to the LLOC forming the extent;
generate a flowchart outlining logic defined by the source code, wherein one flowchart node included in the flowchart commonly represents multiple logic operations defined by the AST nodes corresponding to the extent; and
annotate the one flowchart node with text, wherein the text collectively describes the multiple logic operations.

17. The computer system of claim 16, wherein the text is extracted from the source code.

18. The computer system of claim 16, wherein a size of the one flowchart node is dependent on the text.

19. The computer system of claim 16, wherein a location of the one flowchart node is dependent on a set of characteristics associated with a display of the flowchart.

20. The computer system of claim 16, wherein natural language processing (NLP) is used to determine the text.
